(19) United States
(12) Patent Application Publication
(10) Pub. No.: US 2013/0261839 A1
(43) Pub. Date: Oct. 3, 2013

(54) PORTABLE DEVICE FOR CHANGING OPERATING PARAMETER VALUES AND/OR FIRMWARE OF ELECTRONIC CONTROL UNITS OF MOTOR VEHICLES

(71) Applicant: Sven Meyer, Winsen/Luhe (DE)

(72) Inventor: Sven Meyer, Winsen/Luhe (DE)

(73) Assignee: OBD TUNING GMBH, Hamburg (DE)

(21) Appl. No.: 13/819,139

(22) PCT Filed: Aug. 26, 2011
(86) PCT No.: PCT/EP11/04292

§ 371 Date: Jun. 11, 2013

(30) Foreign Application Priority Data
Aug. 26, 2010 (EP) 10174198.1

(51) Int. Cl. G06F 17/00

(52) U.S. Cl. CPC G06F 17/00
USPC 701/1

(57) ABSTRACT

Some embodiments provide a portable device for modifying operating parameter values and/or firmware of electronic control apparatuses of motor vehicles including storage means, processor means connected to the storage means and adapted to read out firmware components and/or operating parameter values from the storage means, and interface means connected to the processor means and adapted to be releasably connected to the communication terminal of the communication bus. The processor means comprises translation means, by means of which the processor means is able to transmit, receive and interpret data, and is adapted to automatically establish a communication connection, to carry out a survey of the control apparatuses as well as of the communication protocols used by them, and to transmit, for each recognized control apparatus, for which firmware components and/or operating parameter values are stored in the storage means, programming commands and data.

The present invention relates to a portable device for modifying or changing operating parameter values and/or firmware of electronic control apparatuses or means of motor vehicles according to the preamble of claim 1.

Usually, modern motor vehicles comprise a plurality of different electronic control apparatuses by means of which different functional units or subassemblies of the motor vehicle are controlled and which are coupled to a common communication bus. Examples for such control apparatuses or means are motor or engine control apparatuses, transmission control apparatuses and braking system control apparatuses, such as, e.g., control apparatuses for the ABS braking system. The mode of operation of each individual control apparatus is determined by the respective firmware stored therein and, possibly, by respective operating parameters or values of operating parameters stored therein. In this regard it can be desirable or necessary for various reasons to change or modify the firmware and/or operating parameters or operating parameter values, for example in order to remedy an error or to achieve a mode of operation which is better adapted to the intended operating conditions or conditions of use of the motor vehicle.

In connection with the latter possibility it must be taken into consideration that most motor vehicles are distributed in wide areas of the earth in an unmodified form, although very different environmental conditions prevail at different locations. For example, motor vehicle manufacturers distributing their products in the whole of Europe will generally use the same control apparatuses in their motor vehicles independent of whether a motor vehicle is to be delivered to Greece, Portugal, Finland or Sweden. However, the very different climatic and geographic conditions in these countries impose very different requirements on the operation of the motor vehicle. In order to be able to nevertheless distribute the motor vehicles in a uniform configuration, the various control apparatuses must be configured towards a “mean value” or adapted to suitably defined average conditions in such a manner that a reasonable operation in all regions is possible. However, due to this adaptation the motor vehicle cannot be operated in an optimum manner everywhere, so that it is often possible to obtain better results by selective modification of the mode of operation or operating principle of the individual control apparatuses, for example with respect to the fuel consumption, the acceleration behavior are the wear of the motor or engine.

Before this background and also for other reasons, such as, e.g., a desired modification of the function of the onboard communication or entertainment system, it is known to selectively modify the operating parameters and/or firmware of electronic control apparatuses of motor vehicles. For this purpose, devices are utilized, which include either general programmable devices, such as, e.g., computers or laptops, or specialized devices and which are coupled to the communication bus of the respective motor vehicle. In this connection it must be noted that modern motor vehicles comprise a plug-and-socket interface via which a connection of external devices to the communication bus is possible, and that—at least in Europe—a standard plug-and-socket interface is used since about 2001, which, in the case of external devices, enables the use of standard plugs for motor vehicles of different manufacturers and types. This standard plug-and-socket interface is known as a so-called OBD-2 diagnostic female connector (OBD stands for “on-board diagnostics”).

However, with such devices it is necessary for a modification of the values of operating parameters and/or firmware of the electronic control apparatuses that an operator individually addresses each control apparatus and carries out selective operating steps adapted to the respective control apparatus. When doing so, at first data have to be read out from the respective control apparatus and displayed or printed out, and subsequently new data have to be determined and entered, often manually, into the device. Thus, the operator is only able to selectively influence one particular control apparatus at a time.

The use of these devices is further made difficult due to the fact that different motor vehicles are generally distinguished by the kind and the type of the control apparatuses and that different control apparatuses typically operate in accordance with different communication protocols. Therefore, either a separate and specifically adapted or dedicated device is used for each control apparatus, or a device is utilized, which can be used for multiple control apparatuses and the software or control of which must be manually adjusted to the respective control apparatus.

Before this background, the modification of the operating parameters or operating parameter values and/or firmware of the electronic control apparatuses of motor vehicles, in the course of which many different control apparatuses and different motor vehicles shall the influenced in short periods of time, requires a high hardware and software expenditure and a high amount of time and therefore involves high costs. If the owner of a motor vehicle desires a modification, the costs and the expenditure of time are transferred to him or her, and he or she is not able to carry out the modification by himself or herself. The choice of workshops possibly offering these services more cheaply often does not constitute an alternative, because the interventions may be associated with a void of guarantee or damage, if they are carried out improperly.

It is the object of the invention to provide a device for the modification of operating parameter values and/or firmware of electronic control apparatuses or means of motor vehicles, which device is simple in construction and handling and can be manufactured in a cost efficient manner and by means of which the number of necessary operating steps is reduced, while nevertheless being able to influence different control apparatuses, and to provide a corresponding method for modifying operating parameter values and/or firmware of electronic control apparatuses or means of motor vehicles.

This problem is solved by a device having the features of claim 1 and a method having the features of claim 13. Advantageous embodiments of the device and the method are the subject-matter of the respective dependent claims.

According to the present invention it is provided that a device for modifying or changing operating parameters or operating parameter values and/or firmware or firmware components of electronic control apparatuses or means of motor vehicles, such as, e.g., automobiles and trucks, is constructed in a portable manner and comprises an electronic storage means which is adapted to store firmware components and/or values of operating parameters for one or more electronic control apparatuses of a motor vehicle. In other words, different data can be stored in the storage means for different storage means or different data are stored in the storage means, which data correspond to firmware components and/or operating parameter values of, respectively, a particular kind and a particular type of control apparatus or means. Thus, each storage means is associated with a data set or record (firmware components and/or operating parameter values), and one or more data sets are stored in the storage means. For example, the data can relate to an engine control apparatus of type A of the manufacturer B and to a transmission control apparatus of type C of the manufacturer D. As indicated above, the device is adapted for use with motor vehicles in which one or typically multiple electronic control apparatuses or means are connected to a common communication bus of the motor vehicle, which communication bus in turn comprises a communication terminal or connector to which external devices can be connected temporarily.

The term “operating parameter” generally encompasses all parameters for which a change of value results in a modification of the control behavior or, possibly, also the other operation of a control apparatus or means. In accordance with the present invention a “communication bus” is to be understood as any bus system suitable to connect the individual control apparatuses of motor vehicles with each other and with a communication terminal or connector. In the usual manner, the term “firmware” is to be understood as all programs implemented in a control apparatus or means, which programs determine the operation and the mode of operation of the control apparatus, for example implement the execution of a particular control algorithm, the control relationship of which may further include operating parameters. In this connection, operating parameters are understood as, amongst others, in particular also variables within the control relationship and reference values and boundary values. Examples for operating parameters are, e.g., a setpoint or set value of the boost pressure, a setpoint or set value of the throttle position, the amount of fuel injected, etc. Firmware components are to be understood as parts of the firmware or as the entire firmware of a control apparatus.

The portable device further comprises a processor means or unit which is connected to the storage means and adapted for reading out from the storage means firmware components and/or operating parameter values stored in the storage means, and for processing them further in the manner described in the following. The processor means can comprise a single processor or also a group of processors and auxiliary components. It is preferred if the processor means is constructed as simple as possible.

Moreover, the portable device comprises an interface means connected to the processor means, which interface means is adapted for releasably being connected to the communication terminal of the communication bus of a motor vehicle in such a manner that a data exchange between the processor means of the portable device and the electronic control apparatuses of the motor vehicle connected to the communication bus is possible via the communication bus. In other words, the interface means, which will generally comprise a suitable plug, such as for example a plug compatible with the common OBD-2 diagnostics female connector or a plug adapted to a female connector of a particular vehicle manufacturer, can be connected to the communication terminal, and when doing so a data connection is established between the processor means and the communication bus. In the case of usual communication bus systems, which operate according to the master slave principle, it is preferred if the processor means automatically registers itself as bus participant on the communication bus after establishing the connection. In this regard, it is preferred that the processor means takes on the role of a master, whereas the control apparatuses of the vehicle communicate as slaves.

The processor means is provided with a translation means or a translation means is associated with the processor means, which translation means is adapted such that with its help the processor means is able to transmit, receive and interpret data in accordance with a plurality of different communication protocols via the interface means. This means that the processor means is able to communicate with different control apparatuses without further assistance by a user, even if the control apparatuses connected to the respective communication bus operate in accordance with different communication protocols. In this regard, the translation means ensures automatically or under control of the processor means that the control apparatuses receive data from the processor means in a format understandable to them, and that the processor means can receive and understand the data transmitted by the control apparatuses. In this connection, within the present application the term communication protocol encompasses all parameters, formats and rules relevant for the data communication between the processor means and a control apparatus via the communication bus. Amongst others, this also includes the type and form of instructions or commands or the configuration or structure of data packets.

Further, the processor means is adapted in order to automatically establish, in the manner already indicated, following the establishment of a releasable connection of the interface means with the communication terminal of the communication bus of a motor vehicle, a communication connection via the communication bus, i.e., e.g., to register itself for example as master on the communication bus, and to subsequently perform a survey of the individual electronic control apparatuses of the motor vehicle connected to the communication bus as well as of the communication protocols used by the individual electronic control apparatuses. In other words, the processor means at first scans, polls, samples or interrogates the control apparatuses connected to the communication bus in order to determine, for example, which control apparatuses of which manufacturer and of which type or from which series are present. The establishing of the communication connection may further require that the processor means determines which kind of communication bus is present and acts accordingly. Therefore, it is preferred if the processor means (and the translation means) is (are) adapted to recognize different communication busses and to carry out the corresponding steps in order to establish, respectively, a data connection. Further, it is preferred if the processor means is adapted to monitor the onboard voltage and the status of the individual control apparatuses in this connection. The automatic establishment of a communication connection following the establishment of a releasable connection of the interface means with the communication terminal does not exclude that prior to that a switch device, possibly provided on the device, must be actuated, such as, for example, a start button or start switch, or, e.g., the ignition of the vehicle must be switched on.

Finally, the processor means is adapted to automatically determine, following the establishment of the communication connection, for each recognized electronic control apparatus with the help of the translation means whether firmware components and/or operating parameter values are stored in the electronic storage means for this control apparatus, and, if this is the case, to then transmit programming commands and data corresponding to the respective firmware components and/or operating parameter values stored in the storage means to the respective electronic control apparatus via the communication bus in accordance with the communication protocol corresponding to this electronic control apparatus. When doing so, the programming commands and data are adapted by the processor means and the translation means to implement the firmware components and/or operating parameter values in the respective control apparatus. In other words, the programming commands and data received by the addressed control apparatus on the communication bus are configured such that, following receipt, the control apparatus implements the new firmware components and/or operating parameter values in its memory or its memories.

This portable device has the advantage that for the selective modification of the mode of operation of the electronic control apparatuses or means of a motor vehicle it is only necessary to store suitable firmware components and/or operating parameter values for the corresponding control apparatuses in the storage means of the device, wherein the storage may preferably be effected in a uniform or standard format independent of the communication protocols used by the control apparatuses, and to subsequently connect the device to the communication bus of the motor vehicle. The modification of the firmware or operating parameter values then takes place fully automatically, i.e. it operates completely autonomously. The portable device preferably comprises a housing, in which or on which all components of the device are accommodated, and may have a shape similar to that of a USB flash drive or pen drive, and the actual re-programming of the control apparatuses merely requires plugging of this “pen drive” into the matching socket by means of a plug-and-socket connection which can be realized very easily and quickly, and the re-programming can subsequently take place in the sense of a “plug and play” function without further inputs or influences on the process. In particular, the interface means may comprise a plug connector disposed directly on the housing, so that the device can be connected directly without a cable to the communication terminal or can be plugged directly into the corresponding socket. For modifying the properties or characteristics of all control apparatuses of a vehicle it is only necessary to establish a plug-and-socket connection between the device loaded with a data set or data sets with modified data and the communication terminal of a motor vehicle, to wait until the data have been transferred, and to release the plug-and-socket connection again.

If, in a particular case of application, a particular modification of the mode of operation of a particular motor vehicle is to be achieved, the firmware components and/or operating parameter values to be stored in the storage means preferably must be adapted to the respective motor vehicle and the control apparatuses present therein and to the desired modification of their mode of operation. Therefore, in this case the device is preferably adapted to a particular vehicle or a particular type of vehicle by storing a particular total data set, which includes data sets with suitably modified data for the different control apparatuses of the vehicle. This can take place, for example, in that the manufacturer of the motor vehicle produces the corresponding devices for his different motor vehicle types and sends them to workshops or even to end users, wherein regional climatic particularities may, for example, be taken into account. The use of the device is so simple that even the latter are able to operate it. Alternatively, e.g. a workshop could offer to provide a device with a suitable total data set following collecting of the data of a particular motor vehicle and the wishes of its owner with respect to the operating behavior. The device is constructed in such a simple manner and can be manufactured in such a cost-efficient manner that it may be constructed as disposable item for single use—i.e. for a single update or modification of the control apparatuses of a vehicle.

If it is about a fault removal and a general modification of a plurality of control apparatuses, which do not necessarily have to be present together in a vehicle, suitable data sets for all control apparatuses of interest could be stored, so that, in other words, a kind of universal data set collection or universal total data set is generated which is intended for many different vehicles. Then, during the fully automatic re-programming process on a particular vehicle, the portable device automatically selects the data corresponding to the control apparatuses present in the respective case.

In a preferred embodiment the firmware components and/or operating parameter values are stored in the storage means in a standard or uniform format independent of a control apparatus for simplifying the creation and storage of the data sets for different control apparatuses. In this regard, it is further preferred if the processor means and the storage means are adapted in such a manner that the communication between the processor means and the storage means, i.e. reading out data from the storage means and writing data to the storage means, takes place in a standard or uniform communication protocol independent of a control apparatus. In this manner the design and configuration of the device is simplified, because the processor means can communicate with the storage means in a simple manner.

In a preferred embodiment the translation means is integrated into the processor means in such a manner that the processor means directly transmits and receives in the respective communication protocols. In other words, the processor means is constructed in such a manner that not a part of it at first transmits data in a first format to the translation means and the translation means then performs a translation into a second format. Rather, the data to be transmitted on the communication bus are directly generated in the translation means from the data read out from the storage means. This configuration has the advantage that the processor means as a whole can be constructed as integrated component and can, thus, be constructed in a very simple manner.

However, as a result an adaptation of the processor means can be made difficult in case new control apparatuses having new or modified communication protocols have to be taken into account. Therefore, in an alternative preferred embodiment the processor means comprises a main processor and a separate translation means, wherein the translation means is arranged between the main processor and the interface means. The main processor is then adapted to transmit programming commands and data, which are to be transmitted by the main processor via the interface means to a particular control apparatus, at first to the translation means in accordance with a uniform or standard communication protocol. The translation means is further adapted to translate these programming commands and data from the standard communication protocol into the communication protocol of the respective control apparatus, and to retransmit them or pass them on to the interface means in translated form. Conversely, the translation means is also adapted to translate data, transmitted by the respective control apparatus in its communication protocol via the communication bus, into the standard communication protocol and to forward them in this standard communication protocol to the main processor. Then, a modification of the translation function requires no modification and no exchange or replacement of the main processor.

In an advantageous configuration the electronic storage means is provided in a memory element removable from the portable device, or the storage means comprises a removable memory element. This has the advantage that for adapting the portable device to a particular case of application it is merely necessary to store the corresponding total data set in a memory element or memory module, which is then releasably disposed in the portable device, e.g. in a suitable plug-in or connection location or slot. For example, a usual memory card, such as, for example, an SD card, can be utilized for this purpose, which memory card can be simply inserted into a suitable plug-in location or slot in the device. It is possible that in addition to a removable memory element the electronic storage means also comprises a non-removable memory component.

In the case of a removable memory element it can further be advantageous if a key is fixedly stored, and in particular unchangeably stored, both in the removable memory element and in the processor means and the processor means is adapted to operate only if the two keys are matching each other, i.e., for example, coincide or are identical. Such a configuration, in which the removable memory element is married to the processor means, enables a person providing the portable devices to make use of the advantages of a removable memory element with respect to the storage of modified firmware components and/or operating parameter values, but to prevent a later manipulation of the memory element or an undesired passing on or an undesired resale of only the memory element for use in another portable device. In this connection it is preferred if the data are stored in the storage means in an encrypted manner and must be decrypted by the processor means.

It is advantageous if the interface means comprises a plug-and-socket connection element which is adapted to be able to be connected to a communication terminal of the communication bus of a motor vehicle by establishing a plug-and-socket connection, wherein the communication terminal is configured as complementary plug-and-socket connection element. Then, the actual re-programming preferably only requires an insertion or a plugging in of the device into the communication terminal and, following completion of the re-programming, the unplugging.

The communication bus can be configured as K-Line (according to ISO 9141, ISO 14230-1), L-Line or CAN bus (ISO 11898) or as any other bus system suitable for onboard diagnostics (OBD).

In a preferred embodiment the processor means is adapted to determine, after connection of the device to the communication terminal of a particular motor vehicle, whether the device had already been connected earlier to the motor vehicle and, if this was not the case, to read out the firmware components and/or operating parameter values from the control apparatuses and store them as backup copy in the storage means prior to the modification of firmware components and/or operating parameter values to be carried out. Preferably, the backup copy is stored in the same format as the modified firmware components and/or operating parameter values.

In other words, the device as a whole and in particular the processor means are designed to back up, prior to any modification or re-programming of control apparatuses of a vehicle as compared to the original state, this original state in the storage means. When doing so, an original total data set is stored for the respective vehicle, which original total data set includes the original data sets of the individual control apparatuses of the vehicle connected to the communication bus or, possibly, only of those control apparatuses for which a modification is to be effected. Thus, subsequently the original total data set and data sets with modified or adapted firmware components and/or operating parameter values or an adapted or modified total data set for the vehicle are stored in the storage means for the vehicle. In case the modification should not have the desired effects or in case it should be desirable to re-establish the original state for other reasons (for example prior to a sale of the vehicle), the data required for the reversal or kept available in the device in this manner. The determination if the device was already connected to the motor vehicle can be carried out in different manners. For example, it is also possible that a value characteristic of the respective motor vehicle, such as, e.g., the vehicle identification number, is read out by the processor means with the help of the translation means by means of suitable command signals via the communication bus upon user request or, preferably, automatically. The processor means is then adapted to check, preferably automatically, whether a backup copy for the characteristic value read out is already present in the storage means, and to store the backup copy together with an associated indication of the characteristic value. However, it is also conceivable that the processor means is adapted to check whether a backup copy is stored in the storage means at all, and to only store a backup copy if no backup copy whatsoever is yet present. This configuration is particularly simple to realize and advantageous if the device is only intended for use with a particular motor vehicle.

In this embodiment it is particularly preferred if the device comprises a switch being in communication with the processor means and being operable by an operator, which switch has a first switch position and a second switch position, wherein the processor means is adapted to carry out the transmission of programming commands and data corresponding to firmware components and/or operating parameter values to the control apparatuses for implementing the firmware components and/or operating parameter values in the control apparatuses in such a manner that in the first switch position the data correspond to modified firmware components and/or operating parameter values (i.e. the adapted or modified total data set) and, insofar as a backup copy for the respective vehicle is stored in the storage means, in the second switch position correspond to the firmware components and/or operating parameter values of the backup copy. Thus, by actuation of the switch it can be determined whether the control apparatuses are programmed with data sets of original data or with data sets of modified data. Thereby, the restoration of the backup copy and the restoration of the original state are possible at any time in exactly the same simple manner as the modification of firmware components and/or operating parameter values as compared to the original state.

In order to protect control apparatuses from unauthorized and improper modifications, for some control apparatuses it is provided that a modification of firmware components and at least of particular operating parameter values is not possible without first running through an authentication or authorization process. Unauthorized persons or devices are denied the modifying access to the control apparatus. Such an authentication method can be initiated by the control apparatus upon receipt of programming commands and modified data or already in a communication initiating phase before programming commands are accepted at all. These authentication methods are typically configured such that the control apparatus transmits an authentication request code via the communication bus, which authentication request code may be, for example, a multidigit sequence of numbers and is, for example, re-generated according to a random principle upon each authentication. As response to this authentication request code the control apparatus then expects a particular response code, for example again a multidigit sequence of numbers, calculated by an authentication algorithm implemented in the control apparatus. Only if the control apparatus receives the correct response code, it permits a re-programming.

Before this background, in a preferred embodiment a look-up table is stored in the storage means, which look-up table includes, for a plurality of different control apparatuses, a respective authentication or authorization algorithm which may be provided by the manufacturers of the control apparatuses or obtained, for example, by reverse engineering. Further, the processor means is adapted to automatically receive an authentication or authorization request code, determine the authentication algorithm associated with the requesting control apparatus by means of the look-up table, calculate from the authentication request code an authentication response code by means of the authentication algorithm and transmit the authentication response code to the control apparatus, in case a control apparatus, prior to permitting an implementation of modified firmware components and/or operating parameter values, requires an authentication or authorization and transmits a corresponding authentication request code via the communication bus. As with any communication between a control apparatus and the processor means the translation means ensures that the control apparatus receives data and commands in its communication protocol, and that the processor means is able to interpret and process data and commands transmitted by the control apparatus in its communication protocol.

In a preferred embodiment the processor means is configured to automatically read out an identifier characteristic of a motor vehicle, such as the vehicle identification number, immediately after establishing a connection between the interface means of the device and the communication terminal of the communication bus of the motor vehicle, and to only operate as intended if the identifier read out is identical to or coincides with an identifier stored in the storage means. In other words, an identifier characteristic of a particular motor vehicle is stored in the storage means, preferably unchangeably, and the processor means is only able to effect the described modification of firmware components and/or operating parameter values if the identifier of the respective vehicle is identical to or coincides with the stored identifier. Also in this context it is preferred if the data are stored in the storage means in an encrypted manner and must be decrypted by the processor means. In this regard, the encryption can be effected depending on the stored characteristic identifier, and the processor means can be adapted to attempt the decryption depending on the characteristic identifier of the respective connected vehicle.

In an advantageous embodiment the device comprises an indicating means, for example in the form of one or more LEDs, by means of which different operations or operating procedures and/or operating conditions of the device can be indicated. For example, these may be identified by different colors and/or flash patterns. The indicating means is controlled by or with the aid of the processor means. For example, it can be provided that that by means of the indicating means it is indicated that the processor means transmits data to a control apparatus, that the processor means stores data in the storage means, that the processor means carries out a communication operation with the control apparatuses of the connected vehicle in order to carry out a modification of firmware components and/or operating parameter values of the control apparatuses, that such a communication operation and the modification have been carried out successfully, that an error has occurred and/or that the device is successfully registered on the communication bus. Of course, a display could also be provided as indicating means.

It can already be taken from the preceding description that the portable device is adapted in an advantageous manner for use in a method for modifying operating parameter values and/or firmware components of electronic control apparatuses or means of motor vehicles in which the electronic control apparatuses are connected to each other and to a communication terminal via a communication bus. In this regard, a device is provided as has been described in detail above, and firmware components and/or operating parameter values for one or preferably multiple electronic control apparatuses of a motor vehicle or multiple motor vehicles are stored in the storage means of the device. Subsequently, the device is releasably connected by means of its interface means to the communication terminal of the communication bus of a motor vehicle. As has been explained above, the device is adapted to then automatically or essentially automatically (e.g. if it is still necessary to actuate a start button) carry out different method steps, by means of which a modification of operating parameter values and/or firmware components of electronic control apparatuses of the motor vehicle is carried out, provided that at least some of the operating parameter values and/or firmware components stored in the storage means belong to at least one of the control apparatuses of the motor vehicle. It is particularly simple to carry out the storing if the storage means comprises a removable memory element, such as, e.g., a usual SD card, which merely has to be inserted into the prepared remaining device.

In a preferred embodiment the storing of firmware components and/or operating parameter values for at least one electronic control apparatus of a motor vehicle in the storage means of the device can take place in such a manner that it is at first determined for a particular motor vehicle which control apparatuses are present in the vehicle, and subsequently firmware components and/or operating parameter values for one or more of the electronic control apparatuses of the particular motor vehicle are stored in the storage means of the device. This is advantageous if the portable device, e.g. as disposable device, shall only be intended for use with exactly one particular vehicle, for example in order to enable one time only a re-programming of a particular vehicle for modifying its operating characteristics and performance. In this embodiment of the method the above-described embodiments of the device are particularly advantageous in which an identifier characteristic of the particular vehicle is stored in the storage means and/or a removable memory element is married to the processor means.

Further, it can be advantageous to carry out the storing of firmware components and/or operating parameter values for at least one electronic control apparatus of a motor vehicle in the storage means of the device in such a manner that firmware components and/or operating parameter values for a plurality of different electronic control apparatuses of motor vehicles are stored in the storage means of the device. It is then possible that the device is used with many different motor vehicles possibly having very different control apparatuses.

It is also conceivable to design and adapt the device for use with other types of vehicles and to apply the method to such vehicles.

In the following the invention will be described in more detail with reference to exemplary embodiments of the device illustrated in the figures.

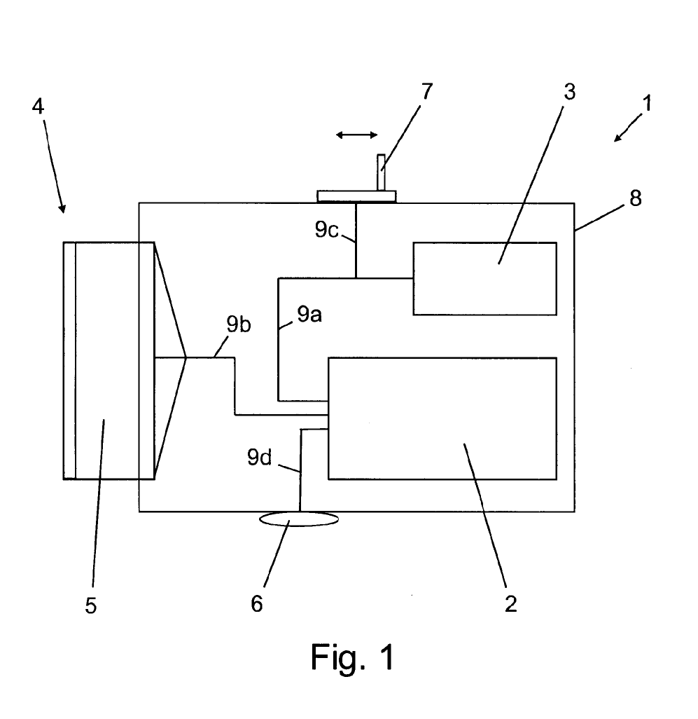

FIG. 1 shows a first exemplary embodiment of a device according to the invention.

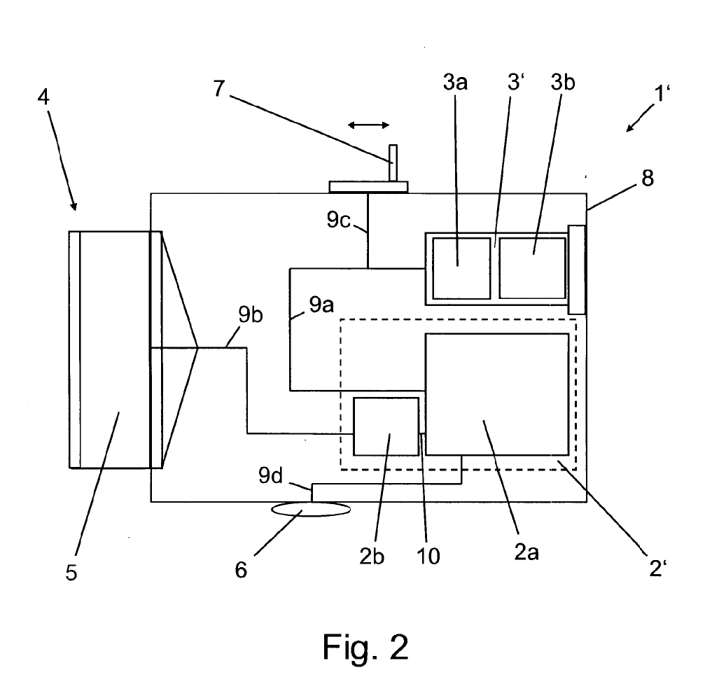

FIG. 2 shows a second exemplary embodiment of a device according to the invention.

The device 1 shown in FIG. 1 comprises a processor means 2, a storage means 3, an interface means 4 having a plug-and-socket connection element 5, an indicating means 6 and a switch 7. The processor means 2 and the storage means 3 are disposed within a housing 8, which may correspond in shape and size to, for example, the housing of a pen drive or a mobile phone.

Between the processor means 2 and the storage means 3 and interface means 4, respectively, communication connections are possible via conductors or conductor paths 9a and 9b, respectively. Further conductors or conductor paths 9c and 9d serve for the connection of the switch 7 and the indicating means 6, respectively, to the processor means 2. The indicating means 6 is mounted on the housing 8 of the device 1 in such a manner that it is clearly visible for a user. It may comprise, for example, one or more LEDs in different colors.

The switch 7 has to different switch positions. A user is able to manually move the switch 7 from one position into the other. In the storage means 3 two data sets or total data sets are stored—as already explained above at least after the first connection of the device 1 to a motor vehicle—one data set with the original data of the control apparatuses of that motor vehicle, to which the device is connected at this moment, and a second data set with the data, which are to be implemented in the control apparatuses and are, thus, to replace the original data. The position of the switch 7 determines which of the two data sets shall be transmitted by the processor means 2 to the control apparatuses of the motor vehicle and shall be implemented there.

The plug-and-socket connection element 5 is constructed in such a manner that it can be brought into plug-and-socket connection or engagement with the diagnostics interface of the motor vehicle, a commercial OBD2 socket. The processor means 2 depicted in FIG. 1 is configured such that the translation means is integrated into the processor means 2 in such a manner that the processor means 2 directly transmits in accordance with different communication protocols. In other words, the translation means is constructed as integral constituent or part of a processor, and not as a component separate with respect to the processor, which component is connected to the processor via, e.g., lines.

In the example shown in FIG. 1 the storage means 3 is constructed in such a manner that it is fixedly incorporated into the device 1.

FIG. 2 shows a further embodiment of the portable device. In contrast to the construction shown in FIG. 1, the processor means 2′ of the device 1′ of FIG. 2 comprises a main processor 2a and a translation means 2b which is constructed as a separate component and which is connected to the main processor 2a via a data line 10. In this regard, the data line 9a between the storage means 3′ and the processor means 2′ is connected to the main processor 2a, while the data line 9b between the interface means 4 and processor means 2′ is connected to the translation means 2b. In this manner the data traffic on the line 9b can advantageously take place in accordance with the communication protocols of the control apparatuses of the vehicle connected to the interface means 4, which communication protocols are translated or are to be translated by the translation means 2b, and the data traffic on the line 10 between the translation means 2b and the main processor 2a can take place in accordance with a uniform or standard communication protocol of the main processor 2a.

Furthermore, the embodiment according to FIG. 2 is distinguished from the embodiment shown in FIG. 1 in that the storage means 3′ comprises two separate memory partitions. The first memory partition 3a is arranged in a memory element not removable from the device. By contrast, the second memory partition 3b is arranged in a memory element removable from the device and constructed in accordance with a commercial mobile memory format, for example SD format, so that the removable memory element can be quickly and easily connected to external reading and programming devices by a user. The removable memory partition and the non-removable memory partition are connected to each other and both to the main processor 2a and to the switch 7 by means of the described lines.

1. A portable device for modifying operating parameter values and/or firmware of electronic control apparatuses of motor vehicles in which the electronic control apparatuses are each connected via a communication bus to each other and to a communication terminal of the communication bus, wherein the device comprises:
an electronic storage means which is adapted to store firmware components and/or operating parameter values for at least one electronic control apparatus of a motor vehicle,
a processor means connected to the storage means and adapted to read out firmware components and/or operating parameter values from the storage means,
an interface means (4) connected to the processor means and adapted to be releasably connected to the communication terminal of the communication bus of a motor vehicle in such a manner that a data exchange between the processor means of the device and the electronic control apparatuses of the motor vehicles connected to the communication is possible via the communication bus,
the processor means comprises a translation means which is configured such that with its help the processor means is able to transmit, receive and interpret data in accordance with a plurality of different communication protocols via the interface means, and
the processor means is adapted to automatically
establish, after the releasable connection of the interface means to the communication terminal of the communication bus of a motor vehicle, a communication connection via the communication bus,
carry out a survey of the individual electronic control apparatuses of the motor vehicle connected to the communication bus as well as of the communication protocols used by the individual electronic control apparatuses, and
to transmit, with the help of the translation means, for each recognized electronic control apparatus, for which firmware components and/or operating parameter values are stored in the electronic storage means, programming commands and data corresponding to the respective firmware components and/or operating parameter values via the communication bus in accordance with the communication protocol corresponding to the electronic control apparatus to the respective electronic control apparatus, wherein the programming commands and data are adapted to implement the firmware components and/or operating parameter values in the respective control apparatus.

2. The portable device of claim 1, wherein the firmware components and/or operating parameter values are stored in the storage means in a uniform format independent of a control apparatus.

3. The portable device of claim 1, wherein the translation means is integrated into the processor means in such a manner that the processor means directly transmits and receives in the respective communication protocols.

4. The portable device of claim 1, wherein the processor means comprises a main processor and a separate translation means, wherein the translation means is provided between the main processor and the interface means and wherein programming commands and data, which are transmitted by the main processor via the interface means to a particular control apparatus, are at first transmitted in accordance with a uniform communication protocol to the translation means, are then translated by the translation means into the communication protocol of the respective control apparatus, and are eventually forwarded to the interface means in translated form, and wherein data transmitted by the respective control apparatus in its communication protocol via the communication bus are translated by the translation means into the uniform communication protocol and are forwarded in it to the main processor.

5. The portable device of claim 1, wherein the electronic storage means is provided in a memory element removable from the portable device.

6. The portable device of claim 5, wherein both in the removable memory element and in the processor means a key is fixedly stored, and in that the processor means is adapted to only operate if both keys match each other.

7. The portable device of claim 1, wherein the interface means comprises a plug-and-socket connection element which is adapted to be able to be connected to a communication terminal of the communication bus of a motor vehicle by establishing a plug-and-socket connection, which communication terminal is configured as complementary plug-and-socket connection element.

8. The portable device of claim 1, wherein the communication bus is configured as K line, L line or CAN bus.

9. The portable device of claim 8, wherein the processor means is adapted to determine, following connection of the device to the communication terminal of a particular motor vehicle, whether the device was already once connected to the motor vehicle, and, if this was not the case, to read out, prior to the modification of firmware components and/or operating parameter values to be carried out, the firmware components and/or operating parameter values from the control apparatuses and to store them as backup copy in the storage means.

10. The portable device of claim 9, wherein the device comprises a user actuatable switch in communication with the processor means, which switch has a first switch position and a second switch position, wherein the processor means is adapted to carry out the transmission of programming commands and data corresponding to firmware components and/or operating parameter values to the control apparatuses for implementing the firmware components and/or operating parameter values in the control apparatuses in such a manner that in the first switch position the data correspond to modified firmware components and/or operating parameter values and, insofar as a backup copy for the respective vehicle is stored in the storage means, in the second switch position correspond to the firmware components and/or operating parameter values of the backup copy.

11. The portable device of claim 1, wherein a look-up table is stored in the storage means, which look-up table includes, for a plurality of different control apparatuses, a respective authentication algorithm, and in that the processor means is adapted to, in case a control apparatus, prior to permitting an implementation of modified firmware components and/or operating parameter values, requires an authentication and transmits a corresponding authentication request code via the communication bus, receive the authentication request code, determine the authentication algorithm associated with the requesting control apparatus by means of the look-up table, calculate from the authentication request code an authentication response code by means of the authentication algorithm and transmit the authentication response code to the control apparatus.

12. The portable device of claim 1, wherein the processor means is configured to
automatically read out an identifier characteristic of a motor vehicle immediately after establishing a connection between the interface means of the device and the communication terminal of the communication bus of the motor vehicle, and
to only operate if the identifier read out coincides with an identifier stored in the storage means.

13. A method for modifying operating parameter values and/or firmware of electronic control apparatuses or means of motor vehicles, in which the electronic control apparatuses are connected to each other and to a communication terminal via a communication bus, using a device according to any of the preceding claims, wherein the method comprises:
providing a device according to any of the preceding claims,
storing firmware components and/or operating parameter values for at least one electronic control apparatus of a motor vehicle in the storage means of the device, and
releasably connecting the interface means of the device to the communication terminal of the communication bus of a motor vehicle.

14. The method of claim 13, wherein the storing of firmware components and/or operating parameter values for at least one electronic control apparatus of a motor vehicle in the storage means of the device is carried out in such a manner that it is at first determined for a particular motor vehicle which control apparatuses are present in the vehicle, and subsequently firmware components and/or operating parameter values for at least one of the electronic control apparatuses of the particular motor vehicle are stored in the storage means of the device.

15. The method of claim 13, wherein the storing of firmware components and/or operating parameter values for at least one electronic control apparatus of a motor vehicle in the storage means of the device is carried out in such a manner that firmware components and/or operating parameter values for a plurality of different electronic control apparatuses of motor vehicles are stored in the storage means of the device.
